(19) United States
(12) Patent Application Publication
(10) Pub. No.: US 2020/0172120 A1
(43) Pub. Date: Jun. 4, 2020

(54) SENSOR DEVICE FOR AN AUTOMATED VEHICLE

(71) Applicant: Robert Bosch GmbH, Stuttgart (DE)

(72) Inventor: Oliver Pink, Ditzingen (DE)

(21) Appl. No.: 16/610,988

(22) PCT Filed: Apr. 12, 2018
(86) PCT No.: PCT/EP2018/059381

§ 371 Date: Nov. 5, 2019

(30) Foreign Application Priority Data
Jun. 14, 2017 (DE) 10 2017 210 045.1

(51) Int. Cl. B60W 50/00; G01S 13/931; G01S 17/931; G01S 15/931

(52) U.S. Cl. CPC B60W 50/0098; G01S 13/931; G01S 17/931; G01S 15/931; G01S 2013/932; G01S 2013/9323; B60W 2420/54; G01S 2013/93271; G01S 2013/93272; G01S 2013/93274; B60W 2520/06; B60W 2420/52; B60W 2420/42; G01S 2013/9324

(57) ABSTRACT

A sensor device for an automated vehicle, having at least one data interface; and an evaluation unit, in which travel route data are able to be supplied to the evaluation unit via the data interface; and an environment detection characteristic of the sensor device is controllable with the aid of the travel route data.

### FIELD OF THE INVENTION

The present invention relates to a sensor device for an automated vehicle. In addition, the present invention relates to a method for operating a sensor device for an automated vehicle. The present invention also relates to a computer program product.

### BACKGROUND INFORMATION

Environment sensors for driver assistance systems, e.g., lidar, video and radar, may have a limited opening angle. A different enlargement of this opening angle often is either impossible (due to stipulations relating to eye safety in the case of lidar, a reduced resolution in the case of video, etc.) or it entails an additional expense.

To a limited extent, current sensors offer the possibility of controlling a field of vision (for instance with the aid of electronic “beam forming” for radar, scanning variations for lidar, or a selection of a subrange for video, etc.).

### SUMMARY OF THE INVENTION

It is an object of the present invention to provide a sensor device for an automated vehicle that offers an improved operating behavior.

According to a first aspect, the objective is achieved by a sensor device for an automated vehicle, the sensor device including:
at least one data interface; and
an evaluation unit;
wherein travel route data are able to be supplied to the evaluation unit via the data interface; and
wherein an environment detection characteristic of the sensor device is controllable using the travel route data.

This allows for a better exploitation of technological limits of the sensor device because—depending on the specific travel route—different environment detection characteristics are realized. In this way a detection performance is able to be increased in the relevant detection range and, in an advantageous manner, less electromagnetic energy is also radiated into the environment.

According to a second aspect, the objective is achieved by a device for operating a sensor device for an automated vehicle, having the steps:
Supplying travel route data via at least one data interface;
evaluating the travel route data using an evaluation unit; and
controlling an environment detection characteristic of the sensor device as a function of the evaluated travel route data using a control device.

Advantageous further developments of the sensor device are the subject matter of the dependent claims.

One advantageous further development of the sensor device provides that the travel route data are developed as trajectory data. With the aid of the trajectory data, a defined number of future vehicle positions is established, such data already being available in automated vehicles. In this way only a low additional effort is advantageously required in order to supply and process the trajectory data for the sensor device.

Another advantageous further development of the sensor device is characterized in that it is possible to consider at least one driving maneuver executed by a driver of the automated vehicle via the data interface. This is accomplished by the transmission of specific data relating to, for example, a steering angle, the activation of a turn signal, a braking maneuver, etc. This ultimately helps in an operation of the sensor device that is even better adapted to the travel route.

Additional advantageous further developments of the sensor device are characterized in that the sensor device is a lidar sensor, a video sensor, a radar sensor or an ultrasonic sensor. This makes it possible to utilize a multitude of different technologies for the sensor device.

According to another advantageous further development of the sensor device, the sensor device is usable as a front sensor system and/or as a side sensor system and/or as a rear sensor system of the automated vehicle. This makes it possible to utilize an optimized environment detection behavior of the sensor device for the automated vehicle. The manifold possibilities for developing the sensor device may be useful when the vehicle is maneuvering through curves having very tight curve radii, for instance.

According to an additional advantageous further development of the sensor device, the environment detection characteristic encompasses a locomotion phase of the vehicle of approximately 5 s to approximately 10 s. In this way the environment detection characteristic of the sensor device has to adapt itself only to a manageable and adequate space region.

In the following text the present invention will be described in detail with further features and advantages using a plurality of figures. All described or illustrated features constitute the subject matter of the present invention, either on their own or in any combination, regardless of their combination in the patent claims or their antecedent references, and also regardless of their formulation or illustration in the description or in the figures. The figures are primarily intended to illustrate the principles that are essential to the present invention.

Disclosed method features similarly result from correspondingly disclosed device features and vice versa. This particularly means that features, technical advantages and developments pertaining to the present method analogously result from corresponding developments, features and advantages of the device, and vice versa.

### BRIEF DESCRIPTION OF THE DRAWINGS

FIG. 1 shows a basic representation of a method of functioning of the introduced sensor device.

FIG. 2 shows a further basic representation of a method of functioning of the introduced sensor device.

FIG. 3 shows a basic block diagram of an introduced sensor device.

FIG. 4 shows a basic sequence of a method for operating a sensor device for an automated vehicle.

### DETAILED DESCRIPTION

In the following text, the term ‘automated motor vehicle’ is used synonymously with the meanings of ‘partially automated motor vehicle’, ‘autonomous motor vehicle’ and ‘partially autonomous motor vehicle’.

An important aspect of the present invention specifically is to provide an environment detection characteristic of an environment sensor system of an automated vehicle such that only the region that is relevant to the currently executed driving maneuver of the vehicle is detected at all times. This exploits the fact that an automated driving function ‘precisely knows’ to which location the vehicle will move in the immediate future because the driving maneuver is fully planned and transmitted, such as in the form of trajectory data, to an actuator system of the vehicle, for example.

It is provided to supply an interface at an environment sensor, via which the already known travel route data are read in. Using suitable calculation rules within the sensor, an environment detection characteristic (e.g., a field of vision, an opening angle, etc.) of the sensor that is optimized for the travel route data is adjusted on that basis.

One advantage of this data interface for travel route data and sensor-internal calculation rules is that the trajectory is easy to calculate for the user of the sensor and is independent of the sensor employed in each case. In an advantageous manner, no sensor-specific knowledge is required for the specification of travel route data in the form of a trajectory. Even third parties are therefore easily able to use the data interface; for example, a manufacturer may generate a trajectory for its own driver assistance function and make it available to the sensor.

Many driver assistance and automated driving functions already plan and ascertain trajectories as it is. If the sensor receives one of the mentioned trajectories that was also actually output to the vehicle control, then it is ensured at all times that precisely the particular detection range of the sensors that the vehicle will pass through during the next manageable time period is covered.

As an alternative to a trajectory, a path may also be specified to the sensor device in a simplified variant, i.e. a geometrical description of a region that the vehicle will pass through in the immediate future, without time information as to when the vehicle will be at a specific location in this region. In contrast to a trajectory with a precise time and speed profile, it is actually possible to control an opening angle of the sensor device on this basis, but this applies only to a limited extent to the control of a field of vision.

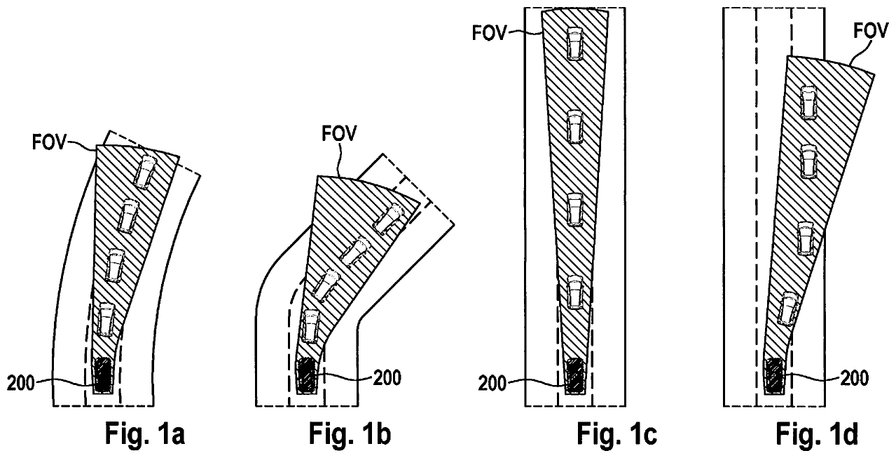

FIG. 1 shows four representations of a schematic exemplary scenario of a method of functioning of provided sensor device 100 for an automated vehicle 200.

An automated vehicle 200 which passes through a curve may be gathered from FIGS. 1a and 1b. The curve in FIG. 1a has a slightly smaller curvature than that in FIG. 1b. It can be seen that the field of vision FOV of the sensor device encompasses the current as well as approximately four future driving positions of vehicle 200, which roughly corresponds to a driving time of automated vehicle 200 of approximately 5 s to approximately 10 s. This ensures that sensor device 100 is adapted to a future travel route of vehicle 200 with regard to its characteristic and its illumination behavior.

FIGS. 1a through 1d show a respective example of a sensor device which is limited in its transmission energy. Depending on the driving maneuver, the field of vision of the sensor device is narrow and wide (see FIGS. 1c, 1d: for example during rapid straight-ahead travel) or wide and short (see FIGS. 1a, 1b: for instance during cornering at a normally lower speed). Depending on the driving direction, the field of vision of the sensor device may be pivoted to the left or right.

Vehicle 200 shown in dark is located at the current vehicle position, and the four vehicles shown in light represent planned or future vehicle positions of vehicle 200 along a trajectory planned for vehicle 200, which, for example, are reached in 1, 2, 3 and 4 seconds in relation to the instantaneous vehicle position. Field of vision FOV represents a field of vision of the sensor of a front sensor system of automated vehicle 200.

FIGS. 1c and 1d indicate that automated vehicle 200 changes from the center lane to the right traffic lane on a three-lane road and then continues its travel there, e.g., at a high speed on a superhighway. For this reason, field of vision FOV of the sensor device is adapted to the current as well as approximately four future positions of vehicle 200.

For example, this allows for a large detection range (“field of vision”) of the sensor device of approximately 300 m to approximately 400 m during rapid straight-ahead travel on superhighways. In contrast, at lower speeds, for example, the illumination range of the sensor device is reduced and the illumination width is increased. By reducing an electrical actuation power of the sensor device, it is also possible to consider the eye safety aspect for the protection of persons located in the environment of the vehicle.

In the final analysis, an optimized operating behavior of the sensor device with an optimized power consumption is able to be realized in this manner.

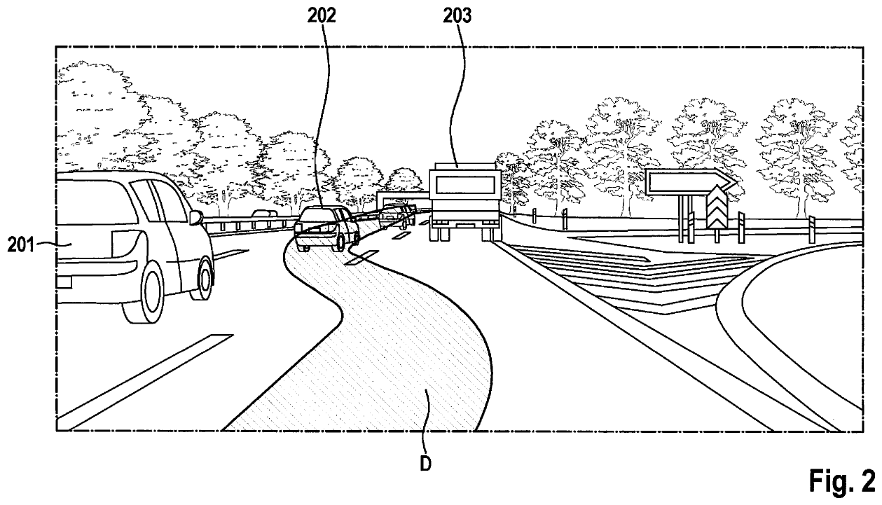

Using a video image of moving vehicle 200 (not shown), FIG. 2 illustrates the travel route data D, which are transmitted to sensor device 100 of vehicle 200. These travel route data D may be configured as trajectory data and indicted in the form of a broad lane in the figure. Stationary objects along this trajectory and in the immediate environment are detectable with greater priority. Stationary objects at a greater distance, e.g., on the right side of the image, are of lesser interest because vehicle 200 will not move in that direction. This allows sensor device 100 to focus primarily on objects or vehicles in the environment of the travel route. In particular vehicle 202 is detected in this manner, while there is no need to take vehicle 202 traveling ahead nor vehicle 201 overtaken on the right into account. This optimizes a detection characteristic of sensor device 100 for the actual traffic lane.

This advantageously makes it possible to reduce the computing time for sensor device 100 or to better concentrate the available computing time/computing capability on the regions that are relevant to the traffic lane. An efficient operating behavior of sensor device 100 is thereby facilitated in an advantageous manner.

In one further development of the sensor device, it may be provided that a specific driver input will be incorporated into an operating characteristic as well, such as in the form of data of a steering angle, a braking maneuver, an actuation of the turn signal, etc.

In an advantageous manner, provided sensor device 100 may also be placed in the rear region of vehicle 200 (not shown), which results in an optimized development of backup maneuvers of the vehicle as well.

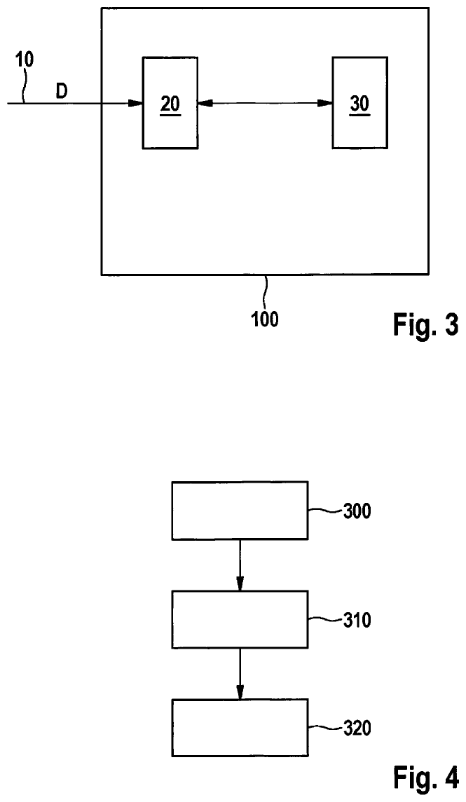

FIG. 3 shows a block diagram of a specific embodiment of provided sensor device 100. A data interface 10 can be seen, which may be configured as a software interface, such as in the form of a bus (e.g., a CAN bus, Ethernet, etc.). Travel route data D are able to be transmitted via data interface 10 to an evaluation unit 20 of sensor device 100. Travel route data D are made available by a planning system in automated vehicle 200 and are normally used for steering and/or engine-control and/or braking purposes.

Based on travel route data D, evaluation unit 20 ascertains the future positions of vehicle 200 and as a result thereof transmits an instruction to control device 30 on the basis of which an operating characteristic of sensor device 100 is adjusted in accordance with travel route data D.

For example, the change in the operating characteristic may be carried out in a manner known per se by a mechanical adjustment of the sensor device and/or an actuation of the sensor device using suitable electrical signals.

In an advantageous manner, greater opening angles than with known sensors can thereby be realized for automated vehicles as a function of the situation. For example, in order to allow for travel through curves with all the radii typically encountered on superhighways, a coverage of approximately ±60°, for example, is required for the front sensor system.

However, when using the provided sensor device it is advantageously not necessary to detect the entire region all at once. As a rule, the region in which the vehicle is actually moving is of particular relevance. For example, when entering a left-hand curve, only the angular range of approximately −60° to approximately 0° could be relevant, and during straight-ahead driving, only the angular range of approximately −30° to approximately +30° could be covered, while in the case of a right-hand curve, only an angular range of approximately 0° to approximately 60° could be covered. The region actually to be covered is therefore never greater than approximately 60° at any given point in time.

This makes it possible to adapt the operating characteristic of sensor device 100 to the travel route data, which advantageously optimizes an operating characteristic of the sensor device.

Provided sensor device 100 is advantageously not tied to a specific technology so that sensor device 100 is able to be developed as a lidar sensor, a video sensor, a radar sensor, an ultrasonic sensor, etc., for example.

In one specific embodiment of the sensor device, which is not illustrated in the figures, it may be the case that sensor device 100 is developed in a “distributed” manner. For example, the evaluation unit and/or the control device may be situated on a separate control device, in which case control signals are transmitted via a further interface to a sensor or to a plurality of sensors. This facilitates the centralized processing using “dumb” sensors.

FIG. 4 shows a basic sequence of one specific embodiment of the method according to the present invention.

In a step 300, the supply of travel route data D is carried out via at least one data interface 10.

In a step 310, travel route data D are evaluated with the aid of an evaluation unit 20.

In a step 320, an environment detection characteristic of sensor device 100 is controlled as a function of evaluated travel route data D with the aid of a control device 30.

In an advantageous manner, the provided method is able to be implemented using a software program that is running on the sensor device, so that a simple adaptability of the present method is supported.

One skilled in the art will modify the features of the present invention in a suitable manner and/or combine them with one another without departing from the core of the present invention.

1-8. (canceled)

9. A sensor device for an automated vehicle, comprising:
at least one data interface; and
an evaluation unit;
wherein travel route data are suppliable to the evaluation unit via the data interface, and
wherein an environment detection characteristic of the sensor device is controllable with the travel route data.

10. The sensor device of claim 9, wherein the travel route data include trajectory data.

11. The sensor device of claim 9, wherein at least one driving maneuver executed by a driver of the automated vehicle is taken into account via the data interface.

12. The sensor device of claim 9, wherein the sensor device includes a lidar sensor, a video sensor, a radar sensor, and/or an ultrasonic sensor.

13. The sensor device of claim 9, wherein the sensor device is usable as a frontal sensor system and/or as a side sensor system, and/or as a rear sensor system of the automated vehicle.

14. The sensor device of claim 9, wherein the environment detection characteristic encompasses a locomotion phase of the vehicle lasting approximately 5 s to approximately 10 s.

15. A method for operating a sensor device for an automated vehicle, the method comprising:
supplying travel route data via at least one data interface;
evaluating the travel route data with an evaluation unit; and
controlling an environment detection characteristic of the sensor device as a function of the evaluated travel route data with a control device.

16. A non-transitory computer readable medium having a computer program, which is executable by a processor, comprising:
a program code arrangement having program code for operating a sensor device for an automated vehicle, by performing the following:
supplying travel route data via at least one data interface;
evaluating the travel route data with an evaluation unit; and
controlling an environment detection characteristic of the sensor device as a function of the evaluated travel route data with a control device.
